(19) United States
(12) Patent Application Publication
(10) Pub. No.: US 2009/0256666 A1
(43) Pub. Date: Oct. 15, 2009

(54) INDUCTOR AND A COIL THEREOF

(76) Inventor: Ming-Ming SHIEH, Taipei City (TW)

Correspondence Address: HDLS Patent & Trademark Services, P.O. BOX 220746, CHANTILLY, VA, 20153-0746, US

(21) Appl. No.: 12/102,074

(22) Filed: Apr. 14, 2008

(51) Int. Cl. H01F 27/02; H01F 27/28

(52) U.S. Cl. 336/90; 336/229; 336/223

(57) ABSTRACT

An inductor includes a casing, a coil and a core. The casing has an accommodating chamber. The casing is provided with two holes in communication with the accommodating chamber. The coil is accommodated in the accommodating chamber. The coil includes a first terminal, a first ring wrapping from a distal end of the first terminal, a second ring wrapped from a distal end of the first ring, and a second terminal extending from a distal end of the second ring. The second ring is formed at the outer periphery of the first ring and extends obliquely and downwardly. The second terminal and the first terminal penetrate through the two holes respectively. The core is disposed in the coil and is accommodated in the accommodating chamber. Via the above arrangement, the vertical space of the present invention can be reduced so as to be made more compact.

### BACKGROUND OF THE INVENTION

1. Field of the Invention

The present invention relates to an electronic element, and in particular to an inductor and a coil thereof.

2. Description of Prior Art

An inductor is also referred to as a coil, which is a passive element that is capable of resisting any change in electric current. The inductor is made by means of wrapping a lead around a core. The core can be made of magnetic or non-magnetic materials. The inductor is an electronic element that is capable of generating a change in magnetic flux via the change in the electric current of the coil and is made based on the principle of magnetic field. The source of the magnetic field derives from running electric charges. An alternating electric current can generate a magnetic field, and a variable magnetic field induces an electric current. The linear relationship between the magnetic field and the electric current is called inductance.

The inductor made by wrapping a lead has a self-induction effect, while the inductor made by wrapping more than one leads has a mutual-induction effect. The function of the inductor is to filter out the noises in the electric current, stabilize the electric current in a circuit, and prevent the interference caused by electromagnetic waves. The function of the inductor is similar to that of a capacitor and is also able to store and release the electric energy in the circuit so as to regulate the stability of the electric current. However, the capacitor stores the electric energy in the form of en electric field (electric charges) while the inductor stores the electric energy in the form of a magnetic field.

The electric field can be transformed into the magnetic filed and vice versa. When an electric current flows through a lead, the periphery of the lead will generate a magnetic field. On the contrary, if a coil intersects a magnetic line of force, an electric current will be generated in the coil. The inductor is made by means of wrapping a lead in such a manner that the respective windings of the lead are close to each other. When an electric current flows through the inductor, magnetic energy will be induced in the inductor. When the electric current becomes smaller, the magnetic energy within the coil will generate a force to block the electric current from changing.

As shown in FIG. 1, the conventional inductor is constituted of a casing 10a, a coil 20a and a core 30a. The casing 10a is constituted of a bottom plate 11a and a cover plate 12a combined on the bottom plate 11a. The bottom plate 11a and the cover plate 12a form an accommodating chamber 13a. The cover plate 12a is provided with two holes 14a in communication with the accommodating chamber 13a. The coil 20a is accommodated in the accommodating chamber 13a. The coil 20a includes a first terminal 21a, a plurality of rings 22a wrapping from a distal end of the first terminal 21a and overlapping with each other, and a second terminal 23a bent to extend from the distal end of the topmost ring 22a. The second terminal 23a and the first terminal 21a penetrate through the two holes 14a respectively. The core 30a is disposed in the coil 20a and is accommodated in the accommodating chamber 13a. Via the above arrangement, an inductor can be obtained.

With the development of modern technology, electronic elements are made more and more compact. Since the coil 20a of the conventional inductor has a plurality of rings 22a that overlap with each other and are made by wrapping a lead, the rings 22a increase the vertical space of the inductor, which affects the compactness of the inductor.

Therefore, it is an important issue to solve the drawbacks of prior art.

### SUMMARY OF THE INVENTION

In view of the above, the present invention is to provide an inductor and a coil thereof. A second ring of the coil is formed at the outer periphery of a first ring and extends obliquely and downwardly. In this way, the vertical space of the coil can be reduced, thereby making the present invention more compact.

The present invention provides an inductor and a coil thereof. The inductor is constituted of a casing, a coil and a core. The casing has an accommodating chamber. The casing is provided with two holes in communication with the accommodating chamber. The coil is accommodated in the accommodating chamber. The coil includes a first terminal, a first ring wrapping from a distal end of the first terminals, a second ring wrapped from a distal end of the first ring, and a second terminal extending from a distal end of the second ring. The second ring is formed at the outer periphery of the first ring and extends obliquely and downwardly. The second terminal and the first terminal penetrate through the two holes respectively. The core is disposed in the coil and is accommodated in the accommodating chamber.

### BRIEF DESCRIPTION OF THE DRAWINGS

FIG. 1 is a cross-sectional view showing the structure of a conventional inductor;

FIG. 2 is an exploded perspective view of the present invention;

FIG. 3 is a cross-sectional view showing the assembled state of the present invention along the line 3-3 in FIG. 2;

FIG. 4 is a perspective view showing the coil of the present invention;

FIG. 5 is a right side view of FIG. 4;

FIG. 6 is a top view of FIG. 4;

FIG. 7 is a schematic view showing another embodiment of the present invention;

FIG. 8 is a side view of FIG. 7;

FIG. 9 is a schematic view showing a further embodiment of the present invention;

FIG. 10 is a top view of FIG. 9;

FIG. 11 is a schematic view showing a further embodiment of the present invention; and

FIG. 12 is a cross-sectional view showing the assembled state of the present invention along the line 12-12 in FIG. 11.

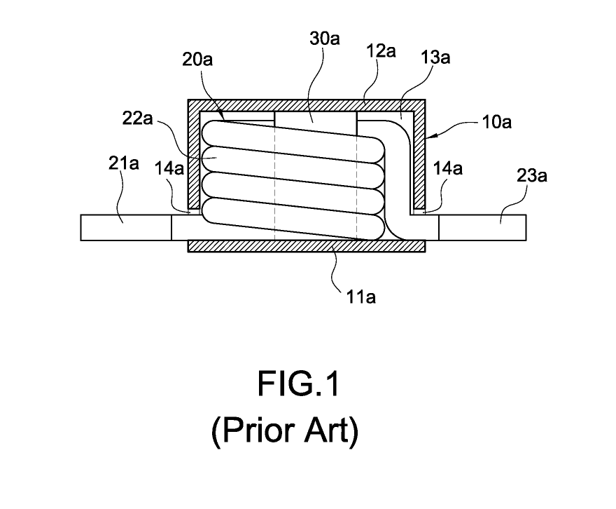

### DETAILED DESCRIPTION OF THE INVENTION

The present invention will be described with reference to a preferred embodiment and accompanying drawings. However, it should be understood that the drawings are illustrative only but not used to limit the scope of the present invention.

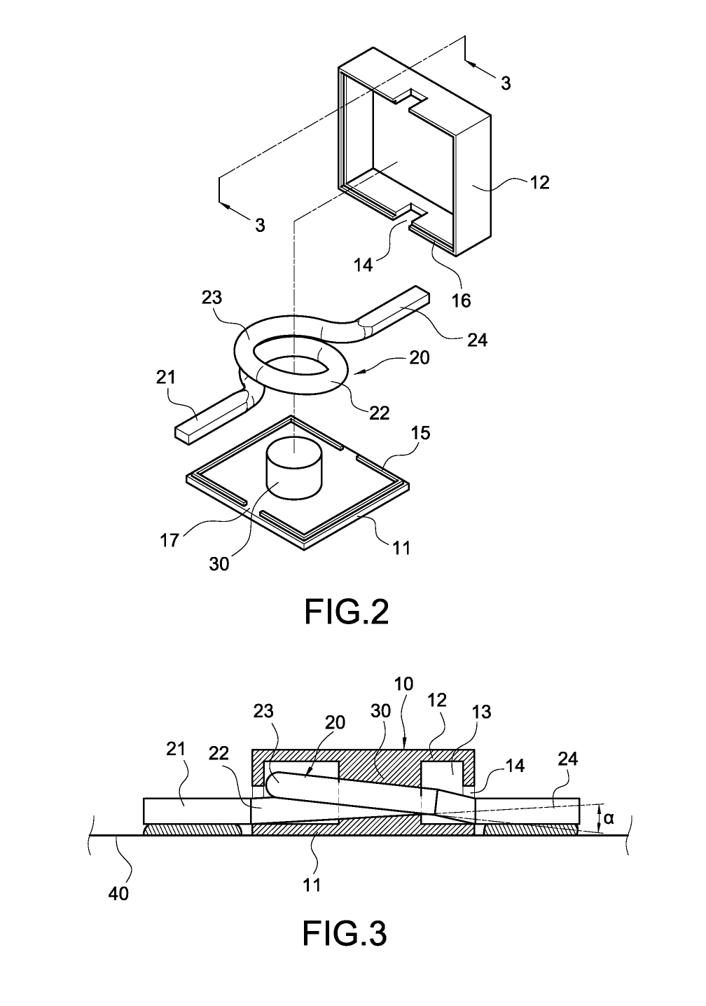

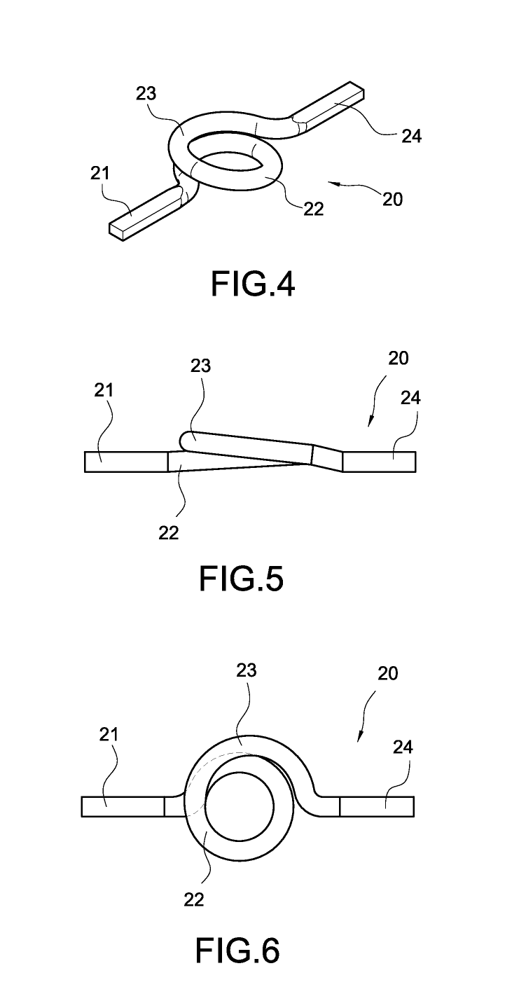

Please refer to FIGS. 2 to 6. The inductor of the present invention is constituted of a casing 10, a coil 20 and a core 30.

The casing 10 comprises a bottom plate 11 and a cover plate 12 provided on the bottom plate 11. The bottom plate 11 and the cover plate 12 form an accommodating chamber 13. both sides of the cover plate 12 are provided with a hole 14 to allow the coil to penetrate through. The bottom plate 11 is provided with a buckling portion 15. The cover plate 12 is provided with a buckled portion 16. The buckling portion 15 is buckled to the buckled portion 16. The buckling portion 15 is a hook, while the buckled portion 16 is a slot. Further, the hole 14 can be made into a rectangular opening.

The coil 20 is made by means of wrapping a lead and is accommodated in the accommodating chamber 13. The coil 20 includes a first terminal 21, a first ring 22 wrapping from the distal end of the first terminal 21, a second ring 23 wrapped from the distal end of the first ring 22, and a second terminal 24 extending from the distal end of the second ring 23. The second ring 23 is formed at the outer periphery of the first ring 22 to be eccentric to the first ring 22 and extends obliquely and downwardly. The second ring 23 intersects with the first ring 22 to form an angle a therebetween. Further, the second terminal 24 and the first terminal 21 are located on the same plane and penetrate through the two holes 14 respectively to be soldered with a circuit board 40.

The cross sections of the first and second terminals 21, 24 are rectangular. Further, the intersecting angle a between the first ring 22 and the second ring 23 is in a range of 5-20 degrees. Preferably, the intersecting angle α is in a range of 10-15 degrees. The respective cross-sectional area of the first and second terminals 21, 24 and the first and second rings 22, 23 is the same.

The core 30 is disposed in the coil 20 and is accommodated in the accommodating chamber 13. The core 30 can be made into a cylinder.

Please refer to FIGS. 2 and 3. In assembling the present invention, the first and second rings 22, 23 of the coil 20 are put around the core 30 standing on the bottom plate 11 with the first and second terminals 21, 24 being located at a positioning slot 17 formed by the buckling portion 15 respectively. Then, the cover plate 12 is covered on the bottom plate 11, so that the coil 20 and the core 30 are accommodated in the accommodating chamber 13 with the first and second terminals 21, 24 penetrating though the two holes 14 respectively, thereby obtaining the present invention. Since the first ring 22 is used as an inner circle while the second ring 23 is used as an outer circle surrounding the outside of the first ring 22, as seen in FIG. 5, the height of the coil 20 merely becomes the resultant height of the overlapped first and second rings 22, 23. Therefore, the present invention can be made more compact.

It should be noted that the inductor of the present invention can be adhered to the circuit board 40 via a Surface Mount Technology (SMT) or can be a Surface Mount Device (SMD). The way of connecting the bottom plate 11 and the cover plate 12 is not limited to the buckling portion 15 and the buckled portion 16 mentioned in the present embodiment. Alternatively, the connecting portion between the bottom plate 11 and the cover plate 12 can be adhered to each other by means of an adhesive.

When the present invention is in use, the first and second terminals 21, 24 of the coil 20 can be soldered with the circuit board 40 or other electronic elements. After the present invention is supplied with electricity, the casing 10 can prevent the magnetic lines of force generated by the coil 20 from being exposed to the outside so as to cause electromagnetic interference to the circuit board 40 or the electronic element. On the other hand, the casing 10 can protect the present invention against the electromagnetic interference caused by other electronic elements.

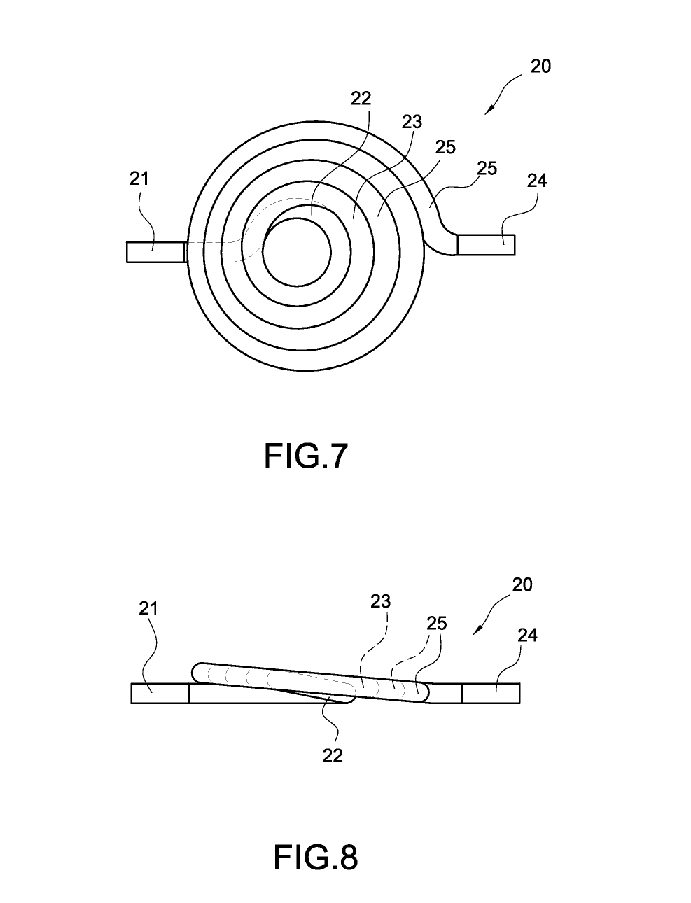

Please refer to FIGS. 7 and 8, which show another embodiment of the present invention. The difference between the present embodiment and the previous embodiment lies in that, in addition to the first and second rings 22, 23, it comprises a plurality of rings 25 wrapping from the distal end of the second ring 23. These rings 25 wrap around the outer periphery of the first ring 22. Therefore, as seen in FIG. 8, the height of the coil 20 merely becomes the resultant height of the overlapped first and second rings 22, 23. Unlike the prior art in which several layers of rings are overlapped, the provision of these rings 25 in the present invention will not increase the actual height of the coil 20. Therefore, with the winding of the coil 20, the vertical space of the coil 20 can be reduced so as to be made more compact.

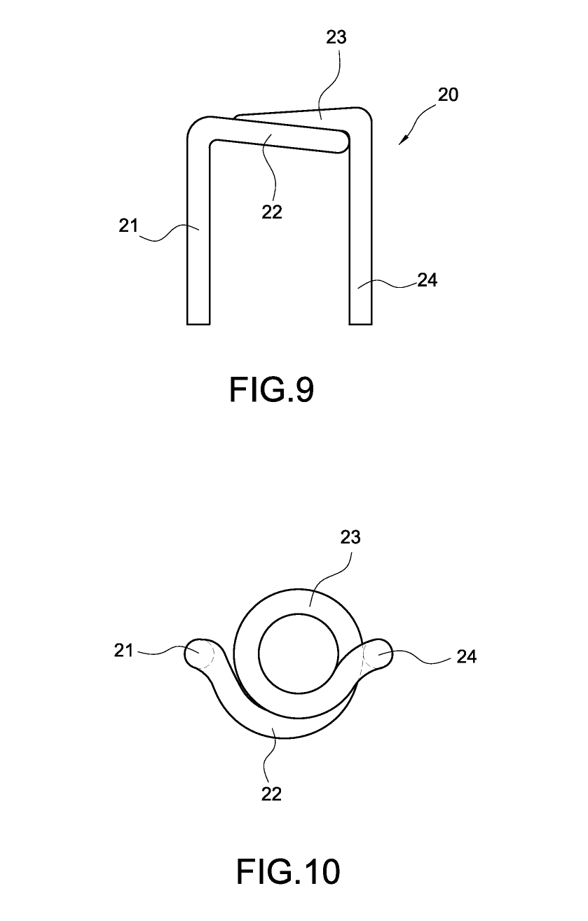

Please refer to FIGS. 9 and 10, which show a further embodiment of the present invention. The difference between the present embodiment and the previous embodiment lies in that the first and second terminals 21, 24 of the coil 20 are oriented downwards to be inserted on the circuit board 40.

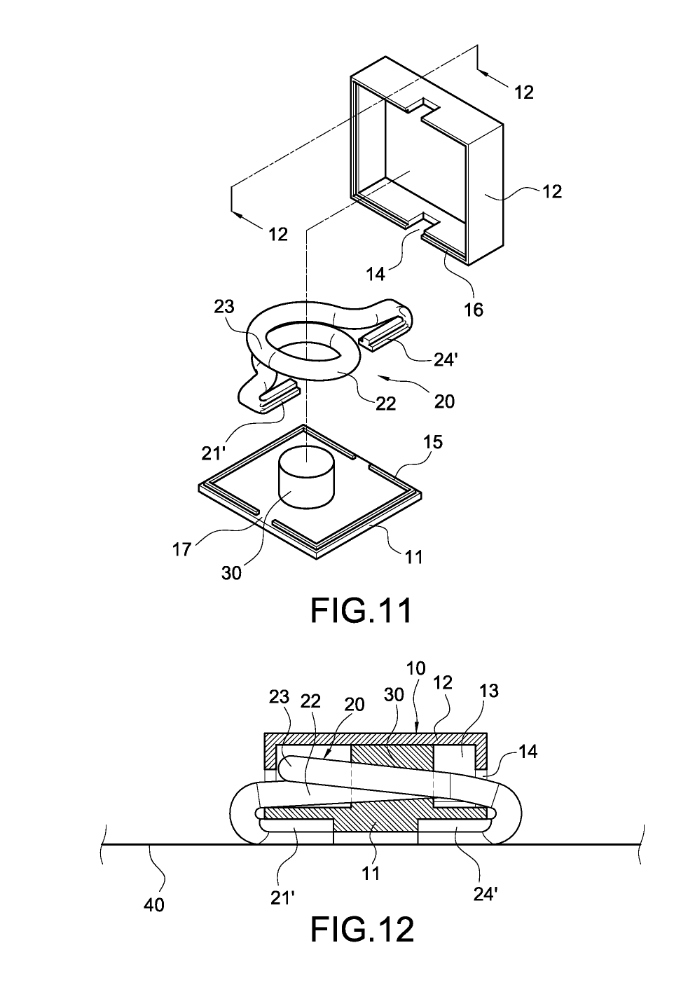

Please refer to FIGS. 11 and 12, which show a further embodiment of the present invention. The difference between the present embodiment and the previous embodiment lies in that the cross sections of the first and second terminals 21′, 24′ of the coil 20 are T-shaped. Further, the first and second terminals 21′, 24′ are oriented downwards to be bent toward the first and second rings 22, 23, so that they can be put on the lower surface of the bottom plate 11 and soldered on the circuit board 40 be means of SMD. The cross-sectional area of each of the first and second terminals 21′, 24′ and the first and second rings 22, 23 is the same.

According to the above, the present invention really achieves the desired objects and solves the drawbacks of prior art. Further, the present invention indeed has novelty and inventive steps, and thus conforms to the requirements for a utility model patent.

What is claimed is:

1. An inductor comprising:
a casing having an accommodating chamber, the casing being provided with two holes in communication with the accommodating chamber;
a coil accommodated in the accommodating chamber, the coil comprising a first terminal, a first ring wrapping from a distal end of the first terminal, a second ring wrapping from a distal end of the first ring, and a second terminal extending from a distal end of the second ring, the second ring being formed on an outer periphery of the first ring and extending obliquely and downwardly, the second terminal and the first terminal penetrating through the two holes respectively; and
a core disposed in the coil and accommodated in the accommodating chamber.

2. The inductor according to claim 1, wherein the casing comprises a bottom plate and a cover plate provided on the bottom plate, the bottom plate and the cover plate form the accommodating chamber, and both sides of the cover plate are respectively provided with another hole to allow a lead to penetrate through.

3. The inductor according to claim 2, wherein the bottom plate is provided with a buckling portion, the cover plate is provided with a buckled portion, and the buckling portion is buckled to the buckled portion.

4. A coil of an inductor, the coil comprising:
a first terminal;
a first ring wrapping from a distal end of the first terminal;
a second ring wrapping from a distal end of the first ring; and
a second terminal extending from a distal end of the second ring, the second ring being formed on an outer periphery of the first ring and extending obliquely and downwardly.

5. The coil of an inductor according to claim 4, wherein the cross sections of the first and second terminals are rectangular.

6. The coil of an inductor according to claim 4, wherein the cross sections of the first and second terminals are T-shaped

7. The coil of an inductor according to claim 4, wherein the first and second terminals are located on the same plane.

8. The coil of an inductor according to claim 4, wherein the first ring is located to be eccentric to the second ring.

9. The coil of an inductor according to claim 4, wherein an intersecting angle between the first ring and the second ring is in a range of 5-20 degrees.

10. The coil of an inductor according to claim 4, wherein an cross-sectional area of each of the first and second terminals and the first and second rings is the same.
